(19) United States
(12) Patent Application Publication
(10) Pub. No.: US 2003/0117495 A1
(43) Pub. Date: Jun. 26, 2003

(54) Connecting device for digital camera on television

(76) Inventors: Kuo-Wen Chen, Hsin-Chu City (TW); Chen-Wen Yang, Hsin-Chu City (TW); Kuan-Chou Ko, Hsin-Chu City (TW)

(21) Appl. No.: 10/248,093

(22) Filed: Dec. 18, 2002

(30) Foreign Application Priority Data
Dec. 21, 2001 (TW) 090223121

(51) Int. Cl. H04N 5/225

(52) U.S. Cl. 348/207.1

(57) ABSTRACT

### Abstract of Disclosure

The invention relates to a digital television with a device for connecting a digital camera, especially to an inside of a digital television where a base being fixed a computer mainframe thereon, and a leading edge of the computer mainframe being against to a control panel of the digital television for an control panel of the computer mainframe becoming a member of the digital television panel thereof; on the other hand, a top end of a rear casing of the digital television around a screen of the digital television is a cavity, which is specially for a connecting device; the connecting device is a USB socket; an end of a signal line connects to the computer mainframe, another end elongates toward up to connect to the connecting device along with an internal side of the rear casing; the connecting device externally connects to the digital camera; as aforesaid, the combination of the digital television and a video device, it seems that components to construct the video device is less so as to that a personal computer can be ignored.

### Background of Invention

1.Field of the Invention:

The invention relates to a digital television, and more particularly, to a digital television with a digital camera.

2.Background of the Invention:

As time goes by, the high technical productions in many fields are improved as much as possible, in particular the display device is fast advanced. To satisfy the different needs of plural fields, the researches and developments of productions tend to multiple additional functions. Particularly, to show pictures with high-speed from digital camera or have a video conference via Internet, the cooperation of digital camera and display device lets video and audio be appeared in the multiple places of the video conference simultaneously, thus each member in the conference can physically feel that they are likely in the same room. The benefit for the above mention is to save the travel cost and avoid travel tiredness and wasting time. Consequently, how to let the digital camera immediately show pictures or fast and simply build up a video conference on site for consumers being willing to use is an important issue in many different fields.

Please refer to FIGURE 1, which is a schematic diagram illustrating the connection of a digital camera 1 and a display device 5 according to the prior art.. Wherein, a digital camera 1 connects to a mainframe of a personal computer 3 via a USB 2 (Universal Serial Bus); then a signal line 4 connects to both ends of the mainframe of the personal computer 3 and a display device 5 (such as a large television) to complete a whole connection. While digital camera 1 purely showing pictures, a software in the digital camera 1 is loaded into the personal computer 3 firstly. The digital camera 1 is then set up and connects to the mainframe of the personal computer 3 by the USB 2; hence the mainframe of the personal computer 3 transforms signals from digital camera 1 into digital signals. An interface card in the mainframe is in charge of transforming to let pictures be presented on the display device. When engaging video transmission in the videoconference, a software in the digital camera 1 is loaded into the personal computer 3 firstly, then to construct digital camera 1 and adjust the lens to a suitable place for photoing each member in the videoconference. Through the USB 2, photoed pictures are input into the mainframe of the personal computer 3 and converted into digital signals. The digital signals continuously are transmitted to each room of the video conference via a wide band on Internet; on the other hand, pictures from any other room located on another far place are shown on the display device of a local room of the video conference by going through the wide band on Internet, and the interface card of the personal computer 3. When aforesaid prior digital camera 1 showing pictures, not only may a supporter be needed for digital camera 1, but also are a personal computer and a television with a large screen required. Further, general consumers are deeply puzzled at those line connections. Therefore, the video device in prior arts has the shortcomings of too many components, long time for assembling, inconvenient usage and maintenance, so the consumers are not willing to use it.

### Summary of Invention

The objective of the present invention is to provide a connecting device for digital camera on digital television. It simplifies the components of constructing a video device and is without using a personal computer for instantly showing pictures.

The other objective of the present invention is to provide a connecting device for digital camera on digital television. . It adopts a way of a build-in computer mainframe and line to connect the digital television with the digital camera for convenience and multiple options.

To reach above objectives, an inside of a digital television where a base being fixed a computer mainframe thereon, and a leading edge of the computer mainframe being against to a control panel of the digital television for an control panel of the computer mainframe becoming a member of the digital television panel thereof; on the other hand, a top end of a rear casing of the digital television around a screen of the digital television is a cavity, which is specially for a connecting device; the connecting device is a USB socket; an end of a signal line connects to the computer mainframe, another end elongates toward up to connect to the connecting device along with an internal side of the rear casing of the digital television; the connecting device externally connects to the digital camera.

### Brief Description of Drawings

Figure 1 is a schematic diagram illustrating the connection of a digital camera 1 and a display device according to the prior art.

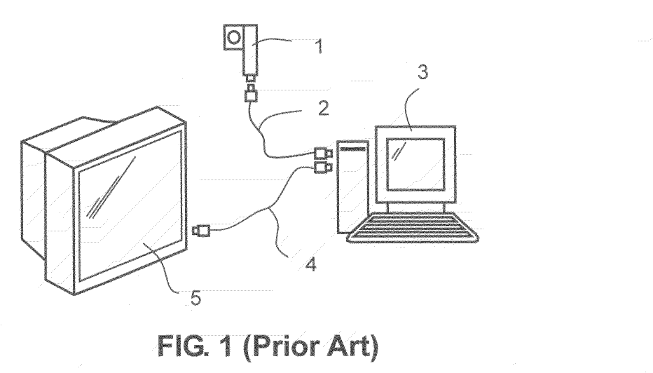

Figure 2 is a layout of a digital camera and a digital television according to the present invention.

Figure 3 is a schematic diagram of related positions of a connecting device and the digital television according to the present invention.

Figure 4 is a perspective view of assembling the digital camera and the digital television according to the present invention.

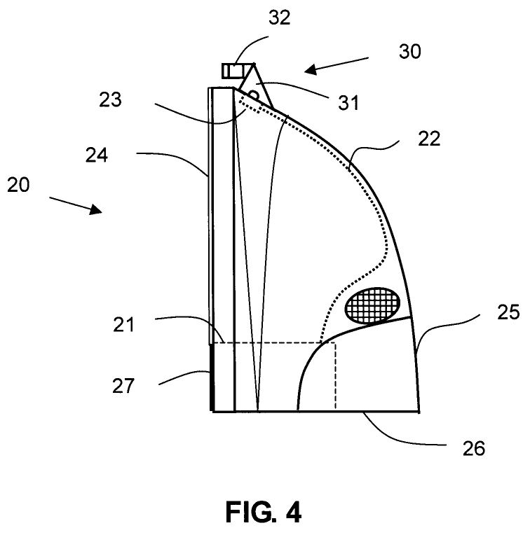

### Detailed Description

A preferred embodiment of the present invention will be explained with reference to the accompanying drawings.

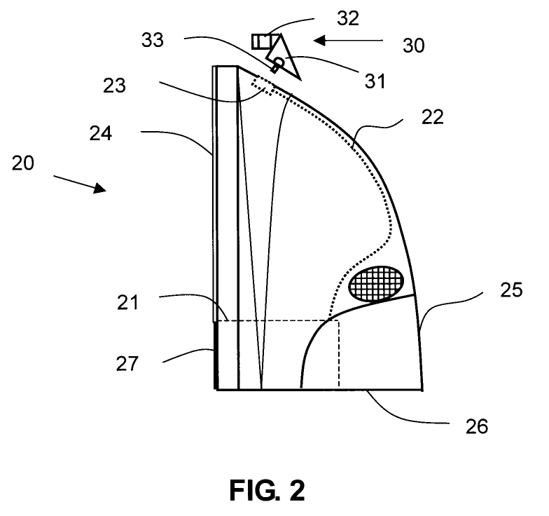

Please refer to FIGURE 2, which is a layout of a digital camera and a digital television according to the present invention. An inside of a digital television 20 is a computer mainframe 21, which connects to a connecting device 23 located on a top of the digital television20 via a signal line 22; the connecting device 23 is able to be externally inserted by a digital camera 30 thereon.

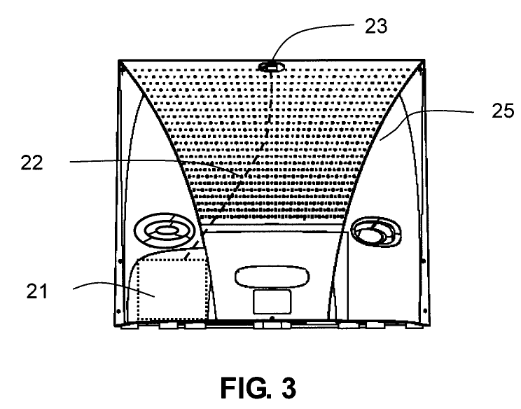

A front of the digital television is a screen 24, whose bottom is an control panel 27; a rear casing 25 is on a rear of the screen 24; a bottom of the rear casing 25 has a base 26; hence, an inside of the digital television 20 is formed by the screen 24, the control panel 27, rear casing 25 and the base 26. A computer mainframe 21 is installed on both a rear of the control panel 27 and a base 26 inside the digital television20. A leading edge of the computer mainframe 21 being against to the control panel 27 of the digital television 20, thus the control panel of the computer mainframe 21 becoming a member of the digital television control panel 27 thereof; on the other hand, showing as in FIGURE 3, a top end of rear casing 25 of the digital television 20 around a screen 24 of the digitaltelevision20 is a cavity, which is specially for a connecting device 23; the connecting device 23 is a USB socket; an end of the signal line 22 connects to the computer mainframe 21, the other end elongates toward up to connect to the connecting device 23 along with an internal side of the rear casing 25.

Additionally, the digital camera has a body 31, a front of the body 31 is a lens 32 with changing variable directions; a bottom surface of the body 31 is about parallel to a surface of the rear casing 25 for adhering; the bottom surface of the body 31 has a USB plug 33, which can be inserted into the connecting device 23 of the rear casing 25 of the digital television20.

In the meantime of using the digital television 20 of the present invention, the digital camera 30 is capable of being inserted into the connecting device 23 of the rear casing 25 of the digital television 20. The signal line 22 is the middle role to connect both sides of the connecting device 23 and the computer frame 21 for picturing in the digital camera 30 being transmitted to the computer mainframe 21. Thus, the computer mainframe 21 controls digital television20 to present pictures on the screen 24. While in a videoconference, the lens 32 of the digital camera 30 can be placed above the digital television20 to take every scene for the conference room and each member attending the conference. Via the signal line 22, pictures from taking scenes are transmitted through the computer mainframe 21, the wide band on Internet to other conference rooms of remote sides; simultaneously, the computer mainframe 21 receives pictures from the other conference rooms of remote sides as well, and controls the digital television 20 to present the pictures on the screen 24 for the whole process of the video conference of network.

Due to the computer mainframe 21 being inside the digital television 20 and the rear casing 25 the of digital television 20 being installed the connecting device 23, components constructing a video device are simplified, and further that pictures in the digital camera 30 can be directly shown on the screen 24 of the digital television 20; hence, the related video devices are easily assembled to operate.

The invention being thus described, it will be obvious that the same may be varied in many ways. Such variations are not to be regarded as a departure from the spirit and scope of the invention, and all such modifications as would be obvious to one skilled in the art are intended to be included within the scope of following claims.

Claims

1.A connecting device for digital camera on digital television comprising:
a digital television having an inside and a rear casing;
a computer mainframe located inside the digital television;
a connecting device attached on the rear casing; and
a signal line connecting both ends of the computer mainframe and the connecting device.

2.The connecting device for digital camera on digital television according to claim 1, wherein the connecting device is a cavity shaped USB (Universal Serial Bus).

3.The connecting device for digital camera on digital television according to claim 2, wherein the connecting device is located on a top of the rear casing.

4.The connecting device for digital camera on digital television according to claim 1, wherein the signal line is installed along an internal side of the rear casing.

5.The connecting device for digital camera on digital television according to claim 1, wherein a leading edge of the computer mainframe is against to a control panel of the digital television, and the control panel is capable of controlling the computer mainframe.
